(19) United States
(12) Patent Application Publication
(10) Pub. No.: US 2024/0314046 A1
(43) Pub. Date: Sep. 19, 2024

(54) CONTROL APPARATUS, CONTROL METHOD AND PROGRAM

(71) Applicant: NIPPON TELEGRAPH AND TELEPHONE CORPORATION, Tokyo (JP)

(72) Inventors: Kengo URATA, Tokyo (JP); Shigeaki HARADA, Tokyo (JP); Ryota NAKAMURA, Tokyo (JP)

(73) Assignee: NIPPON TELEGRAPH AND TELEPHONE CORPORATION, Tokyo (JP)

(21) Appl. No.: 18/274,993

(22) PCT Filed: Feb. 2, 2021
(86) PCT No.: PCT/JP2021/003659

§ 371 Date: Jul. 28, 2023

(51) Int. Cl. H04L 41/40

(52) U.S. Cl. CPC H04L 41/40

(57) ABSTRACT

A control apparatus for embedding, in a physical network, a virtual network that implements provision of a service is provided. The control apparatus includes a memory; and a processor configured to acquire a prediction value of a traffic volume of the service and a prediction value of electric power including renewable energy that is usable by each physical node that constitutes the physical network; acquire information on the physical network; calculate an optimal solution of a two-stage robust optimization problem related to allocation of virtual nodes constituting the virtual network to physical nodes and path determination between the virtual nodes, based on the prediction value of the traffic volume, the prediction value of the electric power, and the information on the physical network; and control the virtual network embedded in the physical network, based on the allocation of the virtual nodes and the path determination represented by the optimal solution.

### TECHNICAL FIELD

The present invention relates to a control apparatus, a control method, and a program.

### BACKGROUND ART

In recent years, with the development of network function visualization (NFV), which is a virtualization technology, it has become possible to provide a huge variety of network services by flexibly combining various virtual network resources (virtual resources (VRs)) and virtual network functions (VNFs). In order to implement the provision of such services, it is necessary to appropriately allocate the VRs and the VNFs to physical resources for each service. In addition, it is also necessary to appropriately determine end-to-end paths. Therefore, a method for performing VNF allocation and path determination under an NFV environment has been proposed in the past.

For example, NPL 1 proposes a method of performing VNF allocation and path determination that not only satisfy communication performance such as communication delay of the entire communication network, but also minimize the power consumption of the entire communication network. For example, in NPL 2, under the assumption that there is uncertainty in a traffic volume related to the service, in consideration of the power consumption of the entire communication network, techniques for the VNF allocation and path determination that are robust to traffic volume uncertainties are proposed.

In recent years, in order to reduce the environmental load, a movement to introduce renewable energy has been advanced in the world. This is no exception to the operation of the virtual network environment, and the proportion of renewable energy in electric power supplied to the communication network is expected to increase. On the other hand, since the supply electric power of renewable energy depends on the natural environment or the like, it is assumed that the electric power usable by the communication network is acquired as a prediction value including a prediction error. That is, it is assumed that the electric power of the renewable energy is acquired as information in which uncertainty exists.

### CITATION LIST

### Non Patent Literature

[NPL 1] M. M. Tajiki, S Salsano, L. Chiaraviglio, M. Shojafar, and B. Akbari, Joint energy efficient and QoS-aware path allocation and VNF placement for service function chaining, IEEE Transactions on Network and service management, 2019

[NPL 2] D. Johansson, A. Kassler, and J. Taheri, On the energy cost of robustness and resiliency for virtual network function placement, 2018 IEEE Conference on Network Function Visualization and Software Defined Networks, 2018

### SUMMARY OF INVENTION

### Technical Problem

However, since the above-mentioned NPL 1 does not consider the existence of uncertainty in the traffic volume related to the service, problems such as deterioration in communication performance and occurrence of congestion may occur. Further, since the above-mentioned NPL 1 and NPL 2 do not consider that the communication network is operated by renewable energy, for example, it is considered that there may occur problems such as an increase in cost due to purchase of insufficient power and an increase in environmental load due to a decrease in utilization rate of renewable energy.

Therefore, the VNF allocation and the path determination are considered to be required in consideration of the uncertainty of both the traffic volume and the renewable energy.

One embodiment of the present invention has been made in view of the above-mentioned point, and it is an object to realize robust virtual network control against uncertainty of traffic volume and uncertainty of renewable energy.

### Solution to Problem

In order to achieve the above object, according to an embodiment, a control apparatus for embedding a virtual network in a physical network is provided. The virtual network implements provision of a service. The control apparatus includes a first acquisition unit configured to acquire a prediction value of a traffic volume of the service and a prediction value of electric power including renewable energy that is usable by each physical node that constitutes the physical network, a second acquisition unit configured to acquire information on the physical network, a solution calculation unit configured to calculate an optimal solution of a two-stage robust optimization problem related to allocation of virtual nodes constituting the virtual network to physical nodes and path determination between the virtual nodes, based on the prediction value of the traffic volume, the prediction value of the electric power, and the information on the physical network and a control unit configured to control the virtual network embedded in the physical network, based on the allocation of the virtual nodes and the path determination represented by the optimal solution.

### Advantageous Effects of Invention

Robust virtual network control against uncertainty of traffic volume and uncertainty of renewable energy can be realized.

### BRIEF DESCRIPTION OF DRAWINGS

FIG. 1 is a diagram illustrating an example of embedding a service in a physical network.

FIG. 2 is a diagram illustrating an example of a hardware configuration of a control apparatus according to the present embodiment.

FIG. 3 is a diagram illustrating an example of a functional configuration of the control apparatus according to the present embodiment.

FIG. 4 is a flowchart illustrating an example of the flow of virtual network control processing according to the present embodiment.

FIG. 5 is a flowchart illustrating an example of a flow of control solution calculation processing according to the present embodiment.

### DESCRIPTION OF EMBODIMENTS

An embodiment of the present invention will be described below. In the present embodiment, a control apparatus 10 capable of realizing robust virtual network control (VNF allocation and path determination) with respect to uncertainty of traffic volume and uncertainty of renewable energy will be described. In the following description, a communication network composed of a physical server requiring power and a physical link is also referred to as a physical network in order to distinguish it from a virtual network. On the other hand, a communication network in which a VNF is a virtual node and a path between VNFs is a virtual link is also referred to as a virtual network.

### Theoretical Configuration

Hereinafter, a theoretical configuration of the present embodiment will be described below.

Problems of identifying a virtual network defined by a combination of a start point (for example, user location, or the like), an end point (for example, server location, or the like), and a VNF (for example, firewall, or the like) used when providing a service with the service provided by this virtual network, and embedding Ns services into a physical network are considered. That is, the problem of embedding Ns virtual networks providing Ns services in a physical network is considered. Here, the virtual link can be divided into an arbitrary number of paths, and can be embedded in one or more physical links connected to physical nodes at an arbitrary ratio.

It is assumed that the topology of the physical network is denoted as g (N, L), where N represents a set of physical nodes, and L represents a set of physical links. In addition, Iₙ CL is a set of physical links flowing into the physical node n ∈N, and Oₙ⊂L is a set of physical links flowing out from the physical node n ∈N. In addition, it is assumed that a set of services is S, and a set related to the kind of VNFs is V. In addition, g, N, L, S, V, and the like are represented by script characters (cursive writing). However, unless it would cause misunderstanding, the characters will be written in normal characters in the text of the specification. Similarly, Oₙ and Iₙ are represented by black-out characters (outlined characters), but are displayed in normal characters in the text of the specification unless it would cause misunderstanding. The same applies to other cursive and outlined characters.

At this time, each service is expressed as g (Vₛ, Eₛ). Here, Vₛ⊂V is a VNF set of the s-th service, and Eₛ is a virtual link set of the s-th service. It is assumed that V also includes a start point node and an end point node of the service.

In addition, the virtual link e∈Eₛ of the s-th service is also interchangeably denoted as (vₛₒ, v_{d}). Here, vₛₒ represents a start point node of the virtual link e, and v_{d} represents an end point node of the virtual link e.

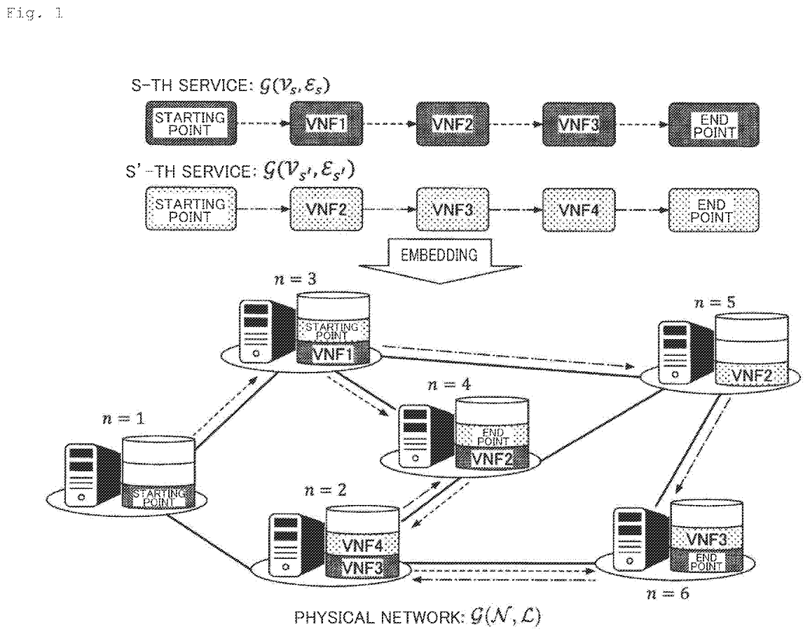

FIG. 1 illustrates an example in which services are embedded in a physical network. In the example illustrated in FIG. 1, a case where the s-th service g (Vₛ, Eₛ) constituted by the start point→VNF1→VNF2→VNF3→the end point and the s′-th service g (V_{s′}, E_{s′}) constituted by the start point→VNF2→VNF3→VNF4→the end point are embedded in the physical network g (N, L) is shown. More specifically, the s-th service g (Vₛ, Eₛ) is embedded in a physical node 1→a physical node 3→a physical node 4→a physical node 2 →a physical node 6. Similarly, the s′-th service g (V_{s′}, E_{s′}) is embedded in the physical node 3→a physical node 5→the physical node 6→the physical node 2→the physical node 4.

The traffic volume generated in the s-th service (hereinafter, referred to as “service s” is defined as λₛ. The traffic volume λₛ may be, for example, a data transfer rate bps or the like. In the case of performing future VNF allocation and path determination, it is assumed that the traffic volume λₛ is obtained as a prediction value by some prediction method. For example, as the prediction method, a time-series model such as an autoregressive model for predicting the future traffic volume from the time-series data of the past traffic volume is constructed, and a prediction value of the future traffic volume is obtained from the time-series model. In addition, for example, a method of using the average and variance of the traffic volume for several days in the past as prediction values may be considered. Since the traffic volume λₛ is the prediction value regardless of what prediction method is used, there is uncertainty (in other words, the traffic volume λₛ is uncertain information). Therefore, it is necessary to consider the problem of embedding the virtual network in consideration of the uncertainty of the traffic volume λₛ.

Next, the electric power required by VNFs, used in each service, and a path (for example, the power consumption Wh of one hour average or the like) is considered. The electric power required by each of the VNFs and the path utilizes maximum power consumption and average power consumption obtained by prior verification or the like before providing the service. On the other hand, as the power source to be supplied to each physical node, renewable energy and contract power are assumed. Since the electric power of the renewable energy depends on the natural environment or the like, the prediction value has uncertainty. Therefore, there is also uncertainty in the maximum electric power Un (hereinafter referred to as the maximum power consumption) that is expected to be used by each physical node n. Therefore, it is necessary to consider the problem of embedding the virtual network in consideration of the uncertainty of the maximum power consumption μₙ.

In the following description, a robust virtual network embedding problem is formulated for uncertainty of traffic volume and uncertainty of renewable energy. As a preparation for this, the uncertainty of the traffic volume and the uncertainty of the maximum power consumption of each physical node will be described as the following polyhedron set.

$$\begin{matrix}[ Math . 1 ] & \\ {Λ}_{s} := \{ {λ}_{s} := {\overline{λ}}_{s} + {ζ}_{s} Δ {λ}_{s} : - 1 \leq {ζ}_{s} \leq 1 , {\sum }_{s ∈ 𝒮} \vert {ζ}_{s} \vert \leq {γ}_{λ} \} & ( 1 )\end{matrix}$$

$${ℳ}_{n} := \{ {μ}_{n} := {\overline{μ}}_{n} + {ζ}_{n} Δ {μ}_{n} : - 1 \leq {ζ}_{n} \leq 1 , {\sum }_{n ∈ 𝒩} \vert {ζ}_{n} \vert \leq {γ}_{μ} \} \qquad ( 2 )$$

Where,

$${\overline{λ}}_{s} ∈ {ℝ}_{+} \qquad [ Math . 2 ]$$

The above expression represents a nominal value of the traffic volume generated in the service s.

$${\overline{μ}}_{n} ∈ {ℝ}_{+} \qquad [ Math . 3 ]$$

The above expression represents a nominal value of the maximum power consumption of the physical node n. Here, the nominal value is a reference value, and for example, a statistical index such as an average value or a median value may be used. In addition, Δλₛ∈R₊ is a deviation from the nominal value of the traffic volume generated in the service s, and Δμₙ∈R₊ is a deviation from the nominal value of the maximum power consumption of the physical node n, and each parameter describes uncertainty.

In the above-mentioned uncertainty set (1), the parameter γ_{λ} is a parameter that adjusts how much deviation exists from the nominal value. Similarly, in the above-mentioned uncertainty set (2), the parameter γ_{μ} is a parameter adjusting how much deviation exists from the nominal value. These parameters γ_{λ} and γ_{μ} may also be parameters defining the size of the uncertainty set.

Under the above preparation, a virtual network embedding problem for minimizing the total cost of the entire virtual network is formulated as the following two-stage robust optimization problem for the uncertainty of the traffic volume and the uncertainty of the maximum power consumption of the physical node described in the above-mentioned uncertainty sets (1) and (2).

$$\begin{matrix}[ Math . 4 ] & \\ {min}_{{x}_{n}^{v , s}} {max}_{{μ}_{n} ∈ {ℳ}_{n}} {\sum }_{s ∈ 𝒮} {\sum }_{n ∈ 𝒩} {\sum }_{v ∈ {𝒱}_{s}} {c}_{n}^{v , s} {x}_{n}^{v , s} + {max}_{{λ}_{s} ∈ {Λ}_{s}} {min}_{{y}_{ℓ}^{e , s} ∈ 𝒴 ( {λ}_{s} , {x}_{n}^{v , s} )} {\sum }_{s ∈ 𝒮} {\sum }_{ℓ ∈ ℒ} {\sum }_{e ∈ {ℰ}_{s}} {b}_{ℓ}^{e , s} {y}_{ℓ}^{e , s} & ( 3 a )\end{matrix}$$

$$s . t . {\sum }_{s ∈ 𝒮} {\sum }_{v ∈ {𝒱}_{s}} {d}_{n}^{v , s} {x}_{n}^{v , s} \leq {μ}_{n} , ∀ n ∈ 𝒩 , \qquad ( 3 b )$$

$${\sum }_{n ∈ 𝒩} {x}_{n}^{v , s} = 1 , ∀ v ∈ {𝒱}_{s} , ∀ s ∈ 𝒮 , \qquad ( 3 c )$$

$${\sum }_{v ∈ {𝒱}_{s}} {x}_{n}^{v , s} \leq 1 , ∀ n ∈ {𝒩}_{s} , ∀ s ∈ 𝒮 , \qquad ( 3 d )$$

$${x}_{n}^{v , s} ∈ \{ 0 , 1 \} , ∀ n ∈ {𝒩}_{s} , ∀ v ∈ {𝒱}_{s} , ∀ s ∈ 𝒮 , \qquad ( 3 e )$$

Here, xₙ^{v,s} is a binary variable, and it takes 1 in a case where the VNF v EV, of the service s is allocated to the physical node n ∈N, and takes 0 in the other cases. In addition, yₗ^{e,s} ∈R (1 is lowercase L) is a continuous variable taking 0 or more and 1 or less, and represents a ratio at which the virtual link e ∈Eₛ of the service s is embedded in the physical link l ∈L. In an objective function (3a), cₙ^{v,s} and bₗ^{e,s} (l is lowercase L) represent cost factors associated with VNF allocation and path determination, respectively. For example, if cₙ^{v,s} and bₗ^{e,s} are set as the power consumption cost for the use of the VNF and the path, the objective function value represents the total power consumption of the entire physical network. For example, when cₙ^{v,s} and bₗ^{e,s} are respectively set as the processing time cost related to the use of the VNF and the path, the objective function value represents the total processing time of the service.

The inequality (3b) expresses the constraint on the maximum power consumption of a physical node, and dₙ^{v,s} is a power consumption coefficient in a case where VNF v ∈Vₛ is assigned to the physical node n. The equation (3c) expresses that each VNF of each service can only be assigned to one physical node. On the other hand, the inequality (3d) means that multiple VNFs cannot be assigned to one physical node in one service. This constraint in this (3d) is seemingly severe and seems to narrow the practical application range. However, for example, by treating a combination of two or more VNFs to be assigned to a certain physical node as one new VNF, it becomes possible to assign two or more VNFs to one physical node.

Furthermore, a set y (λₛ, xₙ^{v,s}) of yₗ^{e,s} that can be taken when the traffic volume λₛ and xₙ^{v,s} are fixed is expressed as follow:

$$\begin{matrix}[ Math . 5 ] & \\ 𝒴 ( {λ}_{s} , {x}_{n}^{v , s} ) := \{ {y}_{ℓ}^{e , s} : 0 \leq {y}_{ℓ}^{e , s} \leq 1 , ∀ n ∈ {𝒩}_{s} , ∀ e ∈ {ℰ}_{s} , ∀ s ∈ {𝒮}_{s} , ( 4 b ) and ( 4 c ) hold \} & ( 4 a )\end{matrix}$$

$${\sum }_{s ∈ 𝒮} {\sum }_{e ∈ {ℰ}_{s}} {λ}_{s} {y}_{ℓ}^{e , s} \leq {ϕ}_{ℓ} , ∀ ℓ ∈ ℒ \qquad ( 4 b )$$

$${\sum }_{ℓ ∈ {𝕆}_{n}} {y}_{ℓ}^{e , s} - {\sum }_{ℓ ∈ {𝕀}_{n}} {y}_{ℓ}^{e , s} = {x}_{n}^{{v}_{so} , s} - {x}_{n}^{{v}_{d} , s} , ∀ n ∈ {𝒩}_{s} , ∀ e ∈ {ℰ}_{s} , ∀ s ∈ {𝒮}_{s} \qquad ( 4 c )$$

The inequality (4b) is the capacity constraint on physical links, where ϕₗ (l is lowercase L) represents the maximum capacity of the physical link l ∈L.

The two-stage robust optimization problem formulated by (3a) to (3e) and (4a) to (4c) is divided into two stages to calculate the solution. First, in a first stage, the VNF allocation xₙ^{v,s} in the scenario in which the maximum power consumption μₙ becomes worst under the condition that the traffic volume λₛ is unknown is determined. In a second stage, the virtual link embedding ratio yₗ^{e,s} (that is, the path) is determined under the condition that the traffic volume ys is known. Thus, control solutions in which uncertainty of traffic volume and uncertainty of renewable energy are taken into consideration (that is, VNF allocation xₙ^{v,s} and path determination yₗ^{e,s}) are obtained, and a robust virtual network control can be realized against these uncertainties. A specific solution-finding procedure will be described below.

A solution algorithm for the two-stage robust optimization problem formulated by (3a) to (3e) and (4a) to (4c) is constructed based on the column-and-constraint generation (C&CG) method. This C&CG method is an algorithm for decomposing an original problem into a master problem and a sub-problem and alternately solving them to obtain a solution to the original problem. Hereinafter, (3a) to (3e) are collectively written as (3). Similarly, (4a) to (4c) are collectively written as (4). For other formula numbers, the same method shall be used when a plurality of formula numbers are written collectively.

The master problem in step K is defined as follows.

$$\begin{matrix}[ Math . 6 ] & \\ {min}_{{x}_{n}^{v , s}} {max}_{{μ}_{n} ∈ {ℳ}_{n}} {\sum }_{s ∈ 𝒮} {\sum }_{n ∈ 𝒩} {\sum }_{v ∈ {𝒱}_{s}} {c}_{n}^{v , s} {x}_{n}^{v , s} + η & ( 5 a )\end{matrix}$$

$$s . t . η \geq {\sum }_{s ∈ 𝒮} {\sum }_{ℓ ∈ ℒ} {\sum }_{e ∈ {ℰ}_{s}} {b}_{ℓ}^{e , s} {y}_{ℓ}^{e , s} ( k ) , ∀ k ∈ 𝒦 , \qquad ( 5 b )$$

$${\sum }_{s ∈ 𝒮} {\sum }_{e ∈ {ℰ}_{s}} {λ}_{s} ( k ) {y}_{ℓ}^{e , s} ( k ) \leq {ϕ}_{ℓ} , ∀ ℓ ∈ ℒ , ∀ k ∈ 𝒦 , \qquad ( 5 c )$$

$${\sum }_{ℓ ∈ {𝕆}_{n}} {y}_{ℓ}^{e , s} ( k ) - {\sum }_{ℓ ∈ {𝕀}_{n}} {y}_{ℓ}^{e , s} ( k ) = {x}_{n}^{{v}_{so} , s} - {x}_{n}^{{v}_{d} , s} , ∀ n ∈ 𝒩 , ∀ e ∈ {ℰ}_{s} , ∀ s ∈ 𝒮 , ∀ k ∈ 𝒦 , \qquad ( 5 d )$$

$$( 3 b ) , ( 3 c ) , ( 3 d ) , and ( 3 e ) hold , η ∈ ℝ .$$

Here, in the above problem, λₛ(K) is the solution of the sub-problem (described later) obtained up to step K-1. In addition, the letter K in cursive is expressed by the following expression.

$$𝒦 := \{ 1 , 2 , … K - 1 \} \qquad [ Math . 7 ]$$

Hereinafter, the optimal solution of the master problem is assumed to be xₙ*^{v,s}(K), η*(K). In particular, xₙ*^{v,s}(K) is used to solve the sub-problem in step K, and η*(K) is used to derive a lower bound for the optimal solution of the original problem (that is, the two-stage robust optimization problem formulated by (3) and (4)). In addition, note that in addition to xₙ^{v,s}, μₙ, the master problem is also solved to obtain the following as a decision variable:

yₗ^{e,s}(k), k∈ [symbol] [Math. 8]

Next, the sub-problem in step K is defined as follows.

$$\begin{matrix}[ Math . 9 ] & \\ {max}_{{λ}_{s} ∈ {Λ}_{s}} {min}_{{y}_{ℓ}^{e , s} ∈ 𝒴 ( {λ}_{s} , {x}_{n}^{* v , s} ( K ) )} {\sum }_{s ∈ 𝒮} {\sum }_{ℓ ∈ ℒ} {\sum }_{e ∈ {ℰ}_{s}} {b}_{ℓ}^{e , s} {y}_{ℓ}^{e , s} & ( 6 )\end{matrix}$$

In the above problem, it is assumed that the optimum values (λₛ*(K), yₗ*^{e,s}(K)) exists. That is, it is assumed that the sub-problem (6) is feasible for any solution of the master problem. In a case where the sub-problem (6) cannot be executed for a solution of the master problem, for example, the control apparatus 10 may output information indicating that the virtual network cannot be embedded.

Since the sub-problem (6) above is a bi-level optimization problem, it is difficult to solve it in its current form. In order to avoid this, the inner minimization problem of sub-problem (6) is converted into a dual problem, resulting in the following single-level maximization problem.

$$\begin{matrix}[ Math . 10 ] & \\ {max}_{{λ}_{s} ∈ {Λ}_{s} , {π}_{ℓ} ∈ ℝ , {ξ}_{n}^{e , s} ∈ ℝ , {θ}_{ℓ}^{e , s} ∈ ℝ} - {\sum }_{ℓ ∈ ℒ} {π}_{ℓ} {ϕ}_{ℓ} + {\sum }_{s ∈ 𝒮} {\sum }_{e ∈ {ℰ}_{s}} {\sum }_{n ∈ 𝒩} {ξ}_{n}^{e , s} ( {x}_{n}^{{v}_{so} , s} - {x}_{n}^{{v}_{d} , s} ) - {\sum }_{s ∈ 𝒮} {\sum }_{ℓ ∈ ℒ} {\sum }_{e ∈ {ℰ}_{s}} {θ}_{ℓ}^{e , s} & ( 7 a )\end{matrix}$$

$$s . t . {b}_{ℓ}^{e , s} + {λ}_{s} {π}_{ℓ} - {ξ}_{n}^{e , s} ( {\sum }_{ℓ ∈ {𝕆}_{n}} {y}_{ℓ}^{e , s} - {\sum }_{ℓ ∈ {𝕀}_{n}} {y}_{ℓ}^{e , s} ) + {θ}_{ℓ}^{e , s} \geq 0 , \qquad ( 7 b )$$

$$∀ n ∈ 𝒩 , ∀ e ∈ {ℰ}_{s} , ∀ s ∈ 𝒮 ,$$

$${π}_{ℓ} \geq 0 , ∀ ℓ ∈ ℒ , {θ}_{ℓ}^{e , s} \geq 0 , ∀ n ∈ 𝒩 , ∀ e ∈ {ℰ}_{s} , ∀ s ∈ 𝒮 . \qquad ( 7 c )$$

In this maximization problem (7), πₗ ∈R, ξₙ^{e,s} ∈R, θₗ^{e,s} ∈R are dual variables for the constraints of (4b), (4c), yₗ^{e,s}≤1. The maximization problem (7) is a nonlinear optimization problem because there is a product of λₛ and πₗ. In this embodiment, the maximization problem (7) is solved by the primal dual interior point method. In the following, the optimal solution of the maximization problem (7) is λₛ*(K), and the objective function value corresponding to this optimal solution is Q (K).

By fixing the λₛ*(K) obtained by the sub-problem up to step K-1 and solving the master problem, the lower bound of the optimal solution in the original problems (3) and (4) is given by following expression:

$${ψ}_{LB} ( K ) = {\sum }_{s ∈ 𝒮} {\sum }_{n ∈ 𝒩} {\sum }_{v ∈ {𝒱}_{s}} {c}_{n}^{v , s} {x}_{n}^{* v , s} + {η}^{*} ( K ) \qquad [ Math . 11 ]$$

On the other hand, by solving the sub-problem by fixing xₙ*^{v,s} obtained in the master problem, the upper bound of the optimal solution in the original problems (3) and (4) is given by following expression:

$${ψ}_{UB} ( K ) = {\sum }_{s ∈ 𝒮} {\sum }_{n ∈ 𝒩} {\sum }_{v ∈ {𝒱}_{s}} {c}_{n}^{v , s} {x}_{n}^{* v , s} ( K ) + 𝒬 ( K ) \qquad [ Math . 12 ]$$

By alternately and repeatedly solving the above master problem (5) and sub-problem (7), it is guaranteed that the upper and lower bounds asymptotically converge to the optimal solution.

### <Hardware Configuration of Control Apparatus 10>

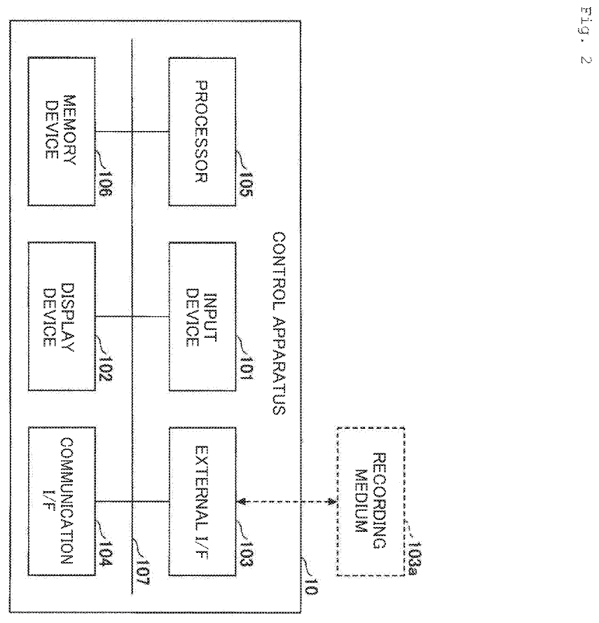

Next, a hardware configuration of the control apparatus 10 according to the present embodiment will be described with reference to FIG. 2. FIG. 2 is a diagram illustrating an example of the hardware configuration of the control apparatus 10 according to the present embodiment.

As illustrated in FIG. 2, the control apparatus 10 according to the present embodiment is implemented by the hardware configuration of a general computer or a computer system and includes an input device 101, a display device 102, an external I/F 103, a communication I/F 104, a processor 105, and a memory device 106. These hardware components are communicably connected to each other via a bus 107.

The input device 101 is, for example, a keyboard, a mouse, a touch panel, or the like. The display device 102 is, for example, a display or the like. The control apparatus 10 may not include at least one of the input device 101 and the display device 102.

The external I/F 103 is an interface with an external device such as a recording medium 103a. The control apparatus 10 can read from and write to the recording medium 103a via the external I/F 103. Examples of the recording medium 103a include a compact disc (CD), a digital versatile disk (DVD), a secure digital memory card (SD memory card), a universal serial bus (USB) memory card, and the like.

The communication I/F 104 is an interface for connecting control apparatus 10 to a communication network. The processor 105 is, for example, various arithmetic units such as a central processing unit (CPU) and a graphics processing unit (GPU). The memory device 106 is, for example, various storage devices such as a hard disk drive (HDD), a solid state drive (SSD), a random access memory (RAM), a read only memory rom (ROM), and a flash memory.

By providing the hardware configuration illustrated in FIG. 2, the control apparatus 10 according to the present embodiment can implement virtual network control processing, which will be described later. The hardware configuration illustrated in FIG. 2 is merely an example, and the control apparatus 10 may have a different hardware configuration. For example, the control apparatus 10 may have a plurality of processors 105 and may have a plurality of memory devices 106.

### <Functional Configuration of Control Apparatus 10>

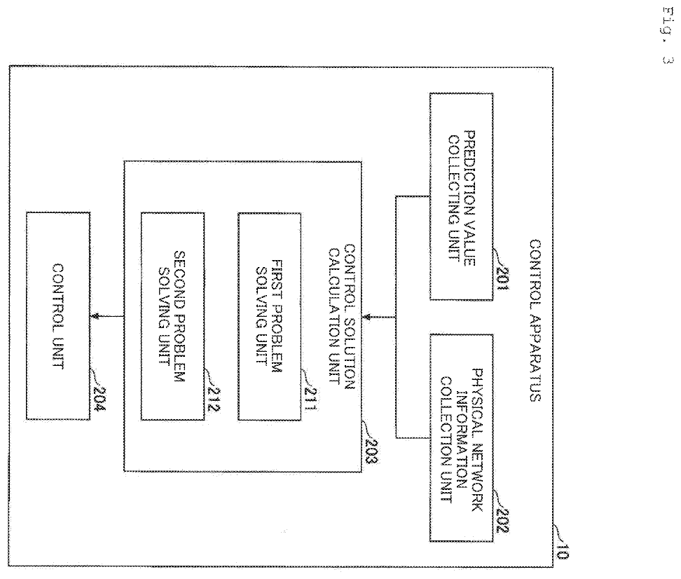

Next, a functional configuration of the control apparatus 10 according to the present embodiment will be described with reference to FIG. 3. FIG. 3 is a diagram illustrating an example of the functional configuration of the control apparatus 10 according to the present embodiment.

As illustrated in FIG. 3, the control apparatus 10 according to the present embodiment includes a prediction value collecting unit 201, a physical network information collecting unit 202, a control solution calculation unit 203, and a control unit 204. Each of these units is implemented by one or more programs installed in the control apparatus 10 causing the processor 105 to execute processing.

The prediction value collecting unit 201 collects a prediction value of a traffic volume of each service and a prediction value of a maximum power amount used in each physical node. That is, the prediction value collecting unit 201 acquires a nominal value and a deviation of a traffic volume of each service, and a nominal value and a deviation of the maximum power consumption in each physical node.

In the present embodiment, it is assumed that the prediction value of the traffic volume of each service and the prediction value of the maximum power consumption in each physical node are obtained by a prediction algorithm or the like using a time series model. For example, in a case where scheduling of the VNF allocation and the path determination in one day in the future is performed, the prediction value collecting unit 201 acquires a prediction value of a traffic volume up to one day ahead and a prediction value of the maximum power consumption by some prediction algorithm. Here, it is assumed that these prediction values are an average value and a variance of a certain sampling interval. In this case, an average value may be set for the nominal value, and a variance may be set for the deviation of the nominal value. The sampling interval is, for example, a time interval set in advance according to the control specifications of VNF allocation and path determination, for example, one minute or one hour.

Note that the nominal value and the deviation thereof collected by the prediction value collecting unit 201 are transferred to the control solution calculation unit 203.

The physical network information collecting unit 202 collects information about the topology of the physical network and various parameters (for example, power consumption coefficient, or the like).

The information collected by the physical network information collecting unit 202, various parameters, and the like are transferred to the control solution calculation unit 203.

The control solution calculation unit 203 executes algorithms for solving the two-stage robust optimization problems (3) and (4), by using the information collected by the prediction value collecting unit 201 and the information collected by the physical network information collecting unit 202. That is, after calculating the VNF allocation xₙ^{v,s} by alternately and repeatedly solving the master problem (5) and the sub-problem (7) in the first stage, the control solution calculation unit 203 solves the sub-problem (6) in the second stage to calculate the path determination yₗ^{e,s}. Accordingly, the VNF assignments xₙ^{v,s} and the path determination yₗ^{e,s} that represent the optimal control solutions to the original problems (3) and (4).

Here, the control solution calculation unit 203 includes a first problem solving unit 211 and a second problem solving unit 212. The first problem solving unit 211 calculates the solution of the master problem (5) and also calculates the lower bounds of the optimal solutions of the original problems (3) and (4). The second problem solving unit 212 calculates the solutions of sub-problem (7) and sub-problem (6), and also calculates the upper bounds of the optimal solutions of the original problems (3) and (4). Note that, for example, in a case where of performing the above-described scheduling, the control solution calculation unit 203 may divide the two-stage robust optimization problems (3) and (4) for each sampling time interval, and then independently execute a solution-finding algorithm for each.

The control unit 204 controls the virtual network by the control solution calculated by the control solution calculation unit 203. Thus, the VNF allocation and the path determination represented by the optimal control solutions are embedded in the physical network (that is, it is changed to the optimal VNF allocation and path determination).

Although, as an example, the case of scheduling the VNF allocation and the path determination in one day in the future has been described, this is one of the application examples and is not limited thereto. For example, the present invention is also applicable to the case where the optimal VNF allocation and path are calculated in real time and the virtual network is dynamically controlled. Specifically, in a case where the prediction value of the traffic volume of each service and the prediction value of the maximum power consumption in each physical node can be collected for each sampling point, the solution algorithm may be executed in the control solution calculation unit 203 each time the collection is performed, and the VNF allocation and the path may be updated in the control unit 204.

### <Virtual Network Control Processing>

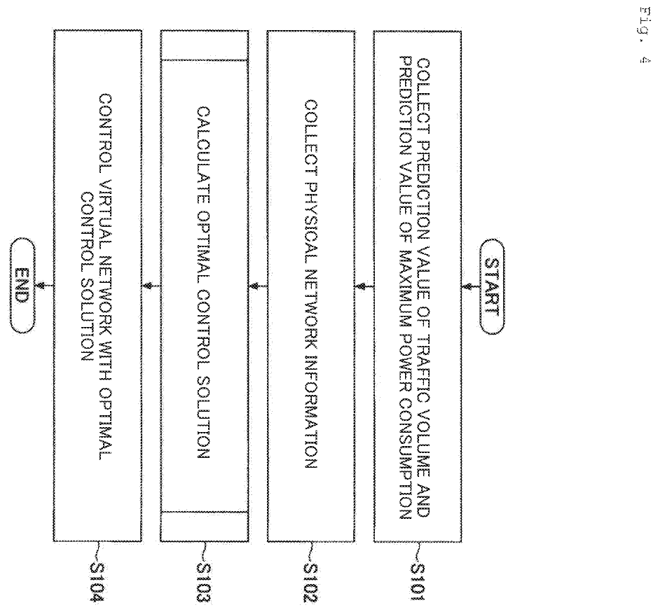

Next, a flow of the virtual network control processing according to the present embodiment will be described with reference to FIG. 4. FIG. 4 is a flowchart illustrating an example of a flow of the virtual network control processing according to the present embodiment. It is assumed that each service g (Vₛ, Eₛ) (s=1, . . . , Nₛ), which is the embedding target, is given to the control apparatus 10.

First, the prediction value collecting unit 201 collects a prediction value of a traffic volume of each service (the nominal value and the deviation thereof), and a prediction value of the maximum power consumption in each physical node (the nominal value and the deviation thereof) (step S101).

Next, the physical network information collecting unit 202 collects information on topology of the physical network, various parameters (for example, a power consumption coefficient) or the like (step S102). However, if the topology of the physical network and the values of various parameters have not been changed after the previous collection, this step may not be executed.

Subsequently, the control solution calculation unit 203 executes an algorithm for solving the two-stage robust optimization problems (3) and (4) by using the information collected in step S102 and the step S103, and calculates optimal control solutions (step S103). Note that the detail of this step will be described later.

Then, the control unit 204 controls the virtual network by the control solution calculated in the step S103 (step S104).

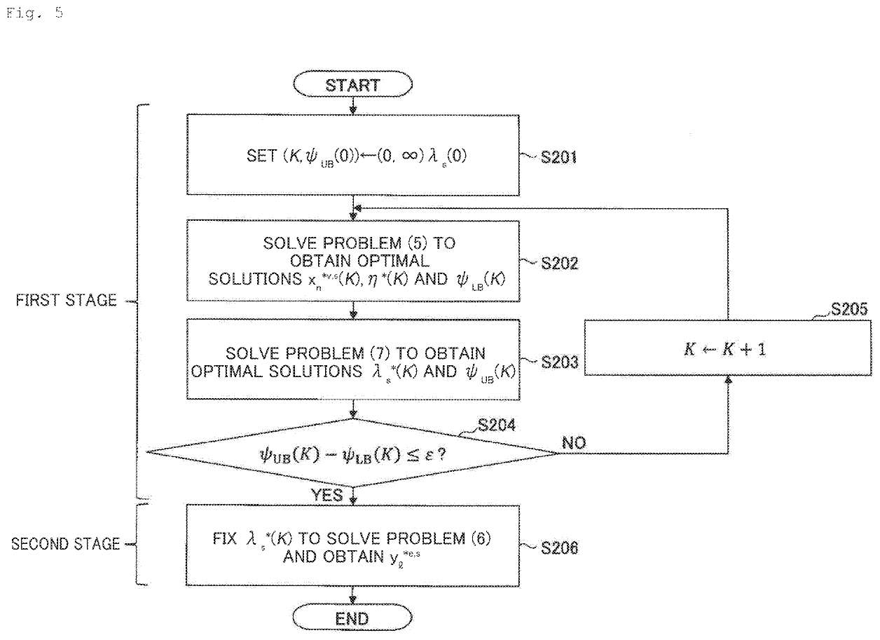

Next, referring to FIG. 5, a description of details of the calculation processing for the control solution in step S103 will be given. FIG. 5 is a flowchart illustrating an example of a flow of the calculation processing according to the present embodiment.

First, the control solution calculation unit 203 sets step K=0, ψ_{UB} (0)=∞, and sets an initial value λₛ (0) (step S201). The initial value λₛ (0) may be set to any value belonging to Λₛ. At this time, the parameter ε>0 for determining the end condition of the first stage may be set to a finite value.

Next, the control solution calculation unit 203 solves the master problem (5) by the first problem solving unit 211 and obtains the optimum solution xₙ*^{v,s}(K), η*(K), and ψ_{LB}(K) (step S202).

Next, the control solution calculation unit 203 solves the sub-problem (7) by the second problem solving unit 212 and obtains the optimal solution λₛ*(K), and ψ_{UB}(K) (step S203). At this time, the control solution calculation unit 203 updates ψ_{UB} (K) by ψ_{UB} (K)=min (ψ_{UB}(K), ψ_{UB}(K-1)).

Next, the control solution calculation unit 203 uses a preset parameter ε (or the parameter ε set in step S201 above) to determine whether ψ_{UB} (K)−ψ_{LB} (K)≤ε is satisfied (step S204).

In a case where it is determined that ψ_{UB} (K)−ψ_{LB} (K)≤ε is not satisfied in step S204 above, the control solution calculation unit 203 adds 1 to step K to update step K (step S205), and returns to step S202. As a result, steps S202 and S203 are repeatedly executed until ψ_{UB}(K)−ψ_{LB}(K)≤ε is satisfied.

On the other hand, in step S204, if it is determined that ψ_{UB}(K)−ψ_{LB}(K)≤ε is satisfied, after fixing λₛ*(K), the control solution calculation unit 203 solves the sub-problem (6) by the second problem solving unit 212 and obtains the optimal solution yₗ*^{e,s} (step S206).

The optimal solutions xₙ*^{v,s}(K) and yₗ*^{e,s} are obtained by the above, and become the optimal control solutions (optimal solutions) to the original problems (3) and (4). In step S206 above, it is necessary to solve the sub-problem (6), but this optimization problem can be reduced to a simple linear programming problem with respect to yₗ^{e,s} so it can be easily solved.

### Conclusion

As described above, the control apparatus 10 according to the present embodiment can perform robust VNF allocation and path determination against the uncertainty of the traffic volume and the uncertainty of the renewable energy by the above-described virtual network control processing.

In a case where the VNF allocation and the path determination are performed by using a prediction value of traffic volume and a prediction value of maximum power consumption including renewable energy, not only deterioration of communication performance and congestion occur but also increase of environmental load due to purchase of insufficient power and reduction of utilization rate of renewable energy may occur as long as prediction errors exist in the prediction values. On the other hand, since the virtual network control processing according to the present embodiment takes into account the existence of uncertainty in prediction, it is possible to perform VNF allocation and path determination which can suppress the deterioration of communication performance and the occurrence of congestion and can prevent the occurrence of the purchase cost of insufficient power and the reduction of the utilization rate of renewable energy.

In addition, the virtual network control processing according to the present embodiment, particularly, the calculation processing of the control solution is a solution algorithm based on the theory of mathematical optimization called two-stage robust optimization. It is known that this theory performs two-stage robust optimization based on the decision making process, and a solution with less maintainability than the mere robust optimization can be obtained. This means that even if there is an error in prediction of traffic volume and renewable energy, VNF allocation and path determination with low maintainability can be performed while suppressing deterioration in communication performance and occurrence of congestion and preventing occurrence of purchase cost of insufficient power and reduction in utilization rate of renewable energy.

The present invention is not limited to the above-described embodiment specifically disclosed, and various modifications and changes, combinations with known technologies, and the like are possible without departing from the description of the claims.

### Reference Signs List

10 Control apparatus
101 Input device
102 Display device
103 External I/F
103a Recording medium
104 Communication I/F
105 Processor
106 Memory device
107 Bus
201 Prediction value collecting unit
202 Physical network information collection unit
203 Control solution calculation unit
204 Control unit
211 First problem solving unit
212 Second problem solving unit

1. An apparatus for allocating a virtual network to a physical network, the apparatus comprising:
a processor; and
a memory storing program instructions that cause the processor to perform allocation of virtual nodes constituting the virtual network to physical nodes or perform path determination between the virtual nodes, based on a prediction value of a traffic volume of a service, a prediction value of electric power of each of the physical nodes, and information on the physical network.

2-5. (canceled)

6. The apparatus according to claim 1, wherein the allocation of the virtual nodes to the physical nodes or the path determination between the virtual nodes are performed so as to minimize a total cost of entirety of the virtual network.

7. The apparatus according to claim 6, wherein the cost is either a power consumption cost or a processing time cost.

8. An apparatus for allocating a virtual network to a physical network, the apparatus comprising:
a processor; and
a memory storing program instructions that cause the processor to
perform allocation of virtual nodes constituting the virtual network to physical nodes or perform path determination between the virtual nodes, based on a prediction value of a traffic volume of a service, a prediction value of electric power of each of the physical nodes, and information on the physical network, the allocation or the path determination being robust to a prediction error in each of the prediction value of the traffic volume and the prediction value of the electric power.

9. A control method performed by an apparatus for allocating a virtual network to a physical network, the control method comprising:
performing allocation of virtual nodes constituting the virtual network to physical nodes or performing path determination between the virtual nodes, based on a prediction value of a traffic volume of a service, a prediction value of electric power of each of the physical nodes, and information on the physical network.
